(19) United States
(12) Patent Application Publication
(10) Pub. No.: US 2009/0040767 A1
(43) Pub. Date: Feb. 12, 2009

(54) Recognition Module

(76) Inventor: Wei-Jung Lin, Taipei (TW)

Correspondence Address: LAW OFFICES OF LAI AND ASSOCIATES, P.C., 5800 RANCHESTER STE 200, HOUSTON, TX, 77036, US

(21) Appl. No.: 11/553,943

(22) Filed: Oct. 27, 2006

(30) Foreign Application Priority Data
Jul. 21, 2006 (TW) 095212904

(51) Int. Cl. F21V 7/00

(52) U.S. Cl. 362/307

(57) ABSTRACT

A recognition module is applied in recognizing counterfeit of a card or a face of the card. The recognition module includes a sealed space, a light emitter, a light receiver and a transparent dustproof plate. The sealed space has two corresponding side inclinations and a transparent cover surface which covers two side inclinations. The light emitter and the light receiver are disposed to the side inclinations respectively. Moreover, the transparent dustproof plate is disposed on the light emitter and the light receiver, and is also disposed under the transparent cover surface. Accordingly, the light emitter and/or the light receiver may not be covered by dust and mists to influence the light-transmitting/receiving efficiency. The recognition rate regarding counterfeit of the card or the face of the card may not be influenced either.

### FIELD OF THE INVENTION

The present invention relates to a card recognition module, and more particularly to the structure improvement of the module and the module that adds a transparent dustproof plate.

### BACKGROUND OF THE INVENTION

Referring to FIG. 1, a schematic diagram illustrates a conventional recognition module. The recognition module 1 comprises an open space 10, a light emitter 11 and a light receiver 12. The open space 10 has a bottom 101 and a side 102. The light receiver 12 can be disposed to the bottom 101. The light emitter 11 can be disposed to the side 102.

Referring to FIG. 2, a schematic diagram illustrates the operation of the conventional recognition module. When a card 20 is disposed upon the recognition module 1, a light beam 21 is emitted by the light emitter 11 to a plane 201 of the card 20, and reflected by the plane 201 to generate a reflective light beam 22 that is transmitted to the light receiver 12. The reflective light beam 22 received by the light receiver 12 is then transformed into an electronic signal that is transmitted to a back-end system for recognizing and analyzing.

It should be noted that the recognition module is an open space. In another word, when the recognition module is disposed to the outside for a while, the light emitter and/or the light receiver may be easily covered by dust and mists. Consequently, the light beam emitted by the light emitter may be unstable. The reflective light beam is also influenced. Moreover, after the influenced reflective light beam received by the light receiver is transformed into an electronic signal that is transmitted to a back-end system, a misjudgment may be generated by the back-end system to influence the recognition rate.

### SUMMARY OF THE INVENTION

To overcome the shortcomings of the conventional recognition module, an object of the present invention is to provide a sealed space to replace the conventional open space in order to overcome the problem of the light emitter and/or the light receiver covered by dust or mists.

Moreover, to ensure the implementation of the sealed space, a second object of the present invention is to provide a transparent cover surface and a transparent dustproof plate to prevent dust or mists.

A third object of the present invention is to provide two corresponding side inclinations in the sealed space for disposing the light emitter and the light receiver respectively. Accordingly, the light beam emitted by the light emitter and the reflective light beam received by the light receiver which corresponds to the light emitter can have consistency.

To achieve the foregoing objects simultaneously, the recognition module disclosed by the present invention comprises a sealed space, a light emitter, a light receiver, and a transparent dustproof plate. The sealed space has a first side inclination, a second side inclination which corresponds to the first side inclination, and a transparent cover surface which covers the first side inclination and the second side inclination. The light emitter and the light receiver are disposed to the first side inclination and the second side inclination respectively. The transparent dustproof plate is disposed upon the light emitter and the light receiver. Moreover, a lower portion of the transparent cover surface which corresponds to the size of the transparent dustproof plate has a clamp groove for clamping the transparent dustproof plate.

Other features and advantages of the present invention and variations thereof will become apparent from the following description, drawings, and claims.

### BRIEF DESCRIPTION OF THE DRAWINGS

FIG. 1 is a schematic diagram illustrating a conventional recognition module;

FIG. 2 is a schematic diagram illustrating the operation of the conventional recognition module;

FIG. 3 is a structural drawing illustrating a recognition module of the present invention; and

FIG. 4 is a schematic diagram illustrating the operation of a recognition module of the present invention.

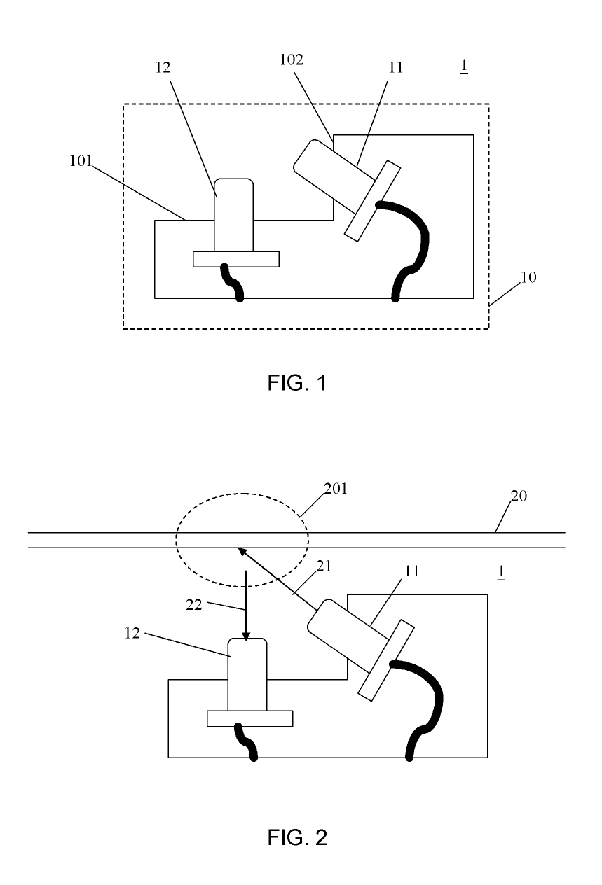

### DETAILED DESCRIPTION OF THE PREFERRED EMBODIMENTS

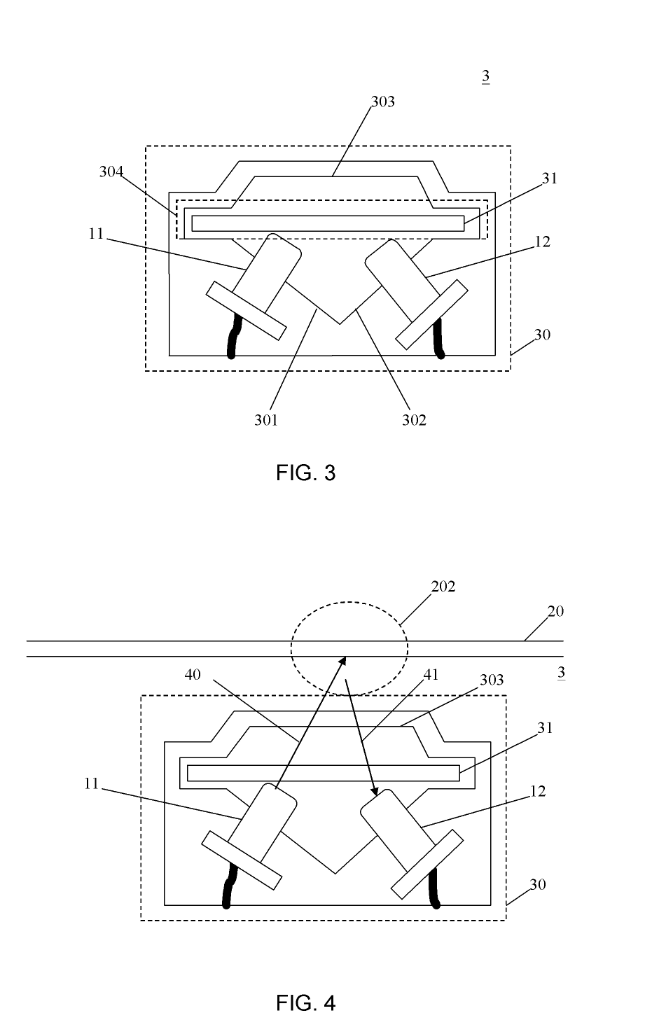

Referring to FIG. 3, a structural drawing illustrates a recognition module of the present invention. The recognition module 3 comprises a sealed space 30, a light emitter 11, a light receiver 12 and a transparent dustproof plate 31. The sealed space 30 has a first side inclination 301, a second side inclination 302 and a transparent cover surface 303. The light emitter 11 is disposed to the first side inclination 301. The light receiver 12 is disposed to the second side inclination 302. Moreover, a clamp groove 304 is extended from the first side inclination 301 and the second side inclination 302 of the sealed space 30. The clamp groove 304 corresponds to the size of the transparent dustproof plate 31 in order to clamp and dispose the transparent dustproof plate 31.

Referring to FIG. 4, a schematic diagram illustrates the operation of the recognition module of the present invention. The recognition module 3 is used to recognize counterfeit of a card 20 and the face of the card 20 such as recognizing the front and the rear of the card 20. The recognition module 3 comprises the sealed space 30, the light emitter 11, the light receiver 12, and the transparent dustproof plate 31 as shown in FIG. 3. When the light emitter 11 emits a light beam 40, the light beam 40 can pass through the transparent dustproof plate 31 and the transparent cover surface 303 to reach a plane 202 of the card 20. A reflective light beam 41 is further generated, and is received by the light receiver 12. Accordingly, the reflective light beam 41 received by the light receiver 12 is transformed into an electronic signal that is transmitted to a back-end system for recognizing and analyzing.

Although the features and advantages of the embodiments according to the preferred invention are disclosed, it is not limited to the embodiments described above, but encompasses any and all modifications and changes within the spirit and scope of the following claims.

What is claimed is:

1. A recognition module comprising:
a sealed space having a first side inclination, a second side inclination corresponding to said first side inclination, and a transparent cover surface covering said first side inclination and said second side inclination;
a light emitter disposed to said first side inclination;
a light receiver disposed to said second side inclination; and
a transparent dustproof plate disposed upon said light emitter and said light receiver and disposed under said transparent cover surface.

2. The recognition module of claim 1, wherein said sealed space corresponds to the size of said transparent dustproof plate, and said sealed space has a clamp groove for clamping said transparent dustproof plate.

3. The recognition module of claim 1, wherein a light beam emitted by said light emitter passes through said transparent dustproof plate and said transparent cover surface.

4. The recognition module of claim 3, wherein the upper portion of said transparent cover surface has a card for reflecting said light beam to said light emitter.

5. A recognition module, applicable for recognizing counterfeit of a card or the face of said card, and said recognition module comprising:
a sealed space;
a light emitter disposed in said sealed space, and for emitting a light beam to a plane of said card to generate a reflective light beam;
a light receiver disposed in said sealed space, and for receiving said reflective light beam; and
a transparent dustproof plate disposed in said sealed space, and disposed upon said light emitter and said light receiver.

6. The recognition module of claim 5, wherein said sealed space corresponds to the size of said transparent dustproof plate, and said sealed space has a clamp groove for clamping said transparent dustproof plate.

7. The recognition module of claim 5, wherein said sealed space further has a first side inclination, a second side inclination corresponding to said first side inclination, and a transparent cover surface covering said first side inclination and said second side inclination.

8. The recognition module of claim 7, wherein said light emitter is disposed to said first side inclination.

9. The recognition module of claim 7, wherein said light receiver is disposed to said second side inclination.

10. The recognition module of claim 7, wherein said light beam and said reflective light beam pass through said transparent dustproof plate and said transparent cover surface.
